(19) United States
(12) Patent Application Publication
(10) Pub. No.: US 2020/0266710 A1
(43) Pub. Date: Aug. 20, 2020

(54) CONTROL CIRCUIT OF BUCK-BOOST CONVERTING APPARATUS AND MODE SWITCHING METHOD OF THE SAME

(71) Applicant: uPI semiconductor corp., Zhubei City (TW)

(72) Inventors: HENG-LI LIN, Zhubei City (TW); JUNG-HUNG TSENG, Zhubei City (TW); HSIN-HAO CHEN, Zhubei City (TW)

(21) Appl. No.: 16/740,556

(22) Filed: Jan. 13, 2020

(30) Foreign Application Priority Data
Feb. 19, 2019 (TW) 108105501

(51) Int. Cl. H02M 3/158; H02M 1/08

(52) U.S. Cl. CPC H02M 3/1582; H02M 2001/0009; H02M 1/08

(57) ABSTRACT

A control circuit of a buck-boost converting apparatus is disclosed. The control circuit includes a current sensing circuit and a mode determination circuit. The current sensing circuit senses an output current of the buck-boost converting apparatus and provides a current sensing signal. The mode determination circuit is coupled to the current sensing circuit and receives the current sensing signal. The mode determination circuit generates a default voltage according to the current sensing signal and a default current, and the mode determination circuit generates a switching control signal according to the default voltage and the current sensing signal to control the buck-boost converting apparatus to be operated in a buck mode, a boost mode or a buck-boost mode.

### BACKGROUND OF THE INVENTION

### 1. Field of the Invention

The invention relates to power conversion; in particular, to a control circuit of a buck-boost converting apparatus and a buck-boost mode switching method of the same.

### 2. Description of the Prior Art

Please refer to FIG. 1. FIG. 1 illustrates a schematic diagram of an output stage of a DC-DC buck-boost converter.

As shown in FIG. 1, the switches SWA and SWB are coupled in series between the input voltage VIN and the ground terminal GND. The gates of the switches SWA and SWB are controlled by the switch control signals UG1 and LG1 respectively, and the switches SWA and SWB are not turned on at the same time. The switches SWD and SWC are coupled in series between the output voltage VOUT and the ground terminal GND. The gates of the switches SWD and SWC are controlled by the switch control signals UG2 and LG2 respectively, and the switches SWD and SWC are not turned on at the same time. One terminal of the output inductor L is coupled to a node X1 between the switches SWA and SWB and the other terminal of the output inductor L is coupled to a node LX2 between the switches SWD and SWC.

The conventional buck-boost mode switching method is to compare the input voltage VIN and the output voltage VOUT to determine whether the DC-DC buck-boost voltage converter 1 should be operated in a buck mode, a boost mode or a buck-boost mode and then switch to corresponding operation mode.

However, once the input voltage VIN is very close to the output voltage VOUT, it is likely to cause a misjudgment of the operation mode, and even cause the DC-DC buck-boost voltage converter 1 to continuously switch between different operating modes. This issue needs to be solved urgently.

### SUMMARY OF THE INVENTION

Therefore, the invention provides a control circuit of a buck-boost converting apparatus and a buck-boost mode switching method of the same to solve the above-mentioned problems of the prior arts.

A preferred embodiment of the invention is a control circuit of a buck-boost converting apparatus. In this embodiment, the control circuit of the buck-boost converting apparatus includes a current sensing circuit and a mode determination circuit. The current sensing circuit is configured to sense an output current of the buck-boost converting apparatus and provide a current sensing signal. The mode determination circuit is coupled to the current sensing circuit and configured to receive the current sensing signal. The mode determination circuit generates a default voltage according to the current sensing signal and a default current, and the mode determination circuit generates a switching control signal according to the default voltage and the current sensing signal to control the buck-boost converting apparatus to be operated in a buck mode, a boost mode or a buck-boost mode.

In an embodiment, the control circuit further includes a pulse width modulation generation circuit. The pulse width modulation generation circuit is coupled to the mode determination circuit and configured to generate a pulse width modulation signal according to the switching control signal.

In an embodiment, the buck-boost converting apparatus further includes a driver and an output stage, the driver is coupled between the pulse width modulation generation circuit and the output stage and configured to generate a plurality of switch control signals to the output stage according to the pulse width modulation signal.

In an embodiment, the pulse width modulation generation circuit further includes a mode switching circuit and a pulse width modulation generator. The mode switching circuit is coupled to the mode determination circuit and configured to generate a mode switching signal corresponding to the buck mode, the boost mode or the buck-boost mode according to the switch control signal. The pulse width modulation generator is coupled to the mode switching circuit and configured to generate the pulse width modulation signal corresponding to the buck mode, the boost mode or the buck-boost mode according to the mode switching signal.

In an embodiment, the mode determination circuit includes the mode determination circuit and a second determination circuit. The first determination circuit is configured to determine a switching between the buck mode and the buck-boost mode according to the default voltage and the current sensing signal. The second determination circuit is configured to determine a switching between the buck-boost mode and the boost mode according to the default voltage and the current sensing signal.

In an embodiment, the current sensing signal is equal to the default voltage at a first time, and the first determination circuit compares the current sensing signal and the default voltage at a second time to generate the switch control signal to control the buck-boost converting apparatus to be operated in the buck mode or the buck-boost mode, and the second time is later than the first time.

In an embodiment, the current sensing signal is equal to the default voltage at a first time, and the second determination circuit compares the current sensing signal with the default voltage at a second time to generate the switch control signal to control the buck-boost converting apparatus to be operated in the buck-boost mode or the boost mode, and the second time is later than the first time.

Another preferred embodiment of the invention is a buck-boost mode switching method applied to a buck-boost converting apparatus. In this embodiment, the buck-boost mode switching method includes the following steps of: sensing an output current of the buck-boost converting apparatus and providing a current sensing signal; generating a default voltage according to the current sensing signal and a default current; and generating a switch control signal according to the default voltage and the current sensing signal to control the buck-boost converting apparatus to be operated in a buck mode, a boost mode or a buck-boost mode.

Compared to the prior art, the control circuit of the buck-boost converting apparatus and the buck-boost mode switching method of the same in the invention can determine whether the operation mode of the buck-boost converting apparatus should be switched or not according to the output current sensing result of the buck-boost converting apparatus, so that the problem that the buck-boost converting apparatus is continuously switched between different operation modes because the comparator fails to perform accurate determination according to the comparison result of the input voltage and the output voltage in the prior art can be effectively avoided, so that the buck-boost converting apparatus of the invention can be continuously operated in correct operation mode to provide optimal voltage converting performance.

The advantage and spirit of the invention may be understood by the following detailed descriptions together with the appended drawings.

### BRIEF DESCRIPTION OF THE APPENDED DRAWINGS

FIG. 1 illustrates a schematic diagram of the output stage of the DC-DC buck-boost converter.

FIG. 2 illustrates a schematic diagram of the buck-boost converting apparatus in an embodiment of the invention.

FIG. 3 illustrates a detailed schematic diagram of the buck-boost converting apparatus.

FIG. 4 illustrates a schematic diagram of the pulse width modulation generation circuit including the mode switching circuit.

FIG. 5 illustrates an embodiment of the first determination circuit and the current sensing circuit.

FIG. 6 illustrates a timing diagram of the switch control signal, the output current, the current sensing signal, the default voltage, the enable signal and the latch signal when the first determination circuit is operated.

FIG. 7 illustrates an embodiment of the second determination circuit and the current sensing circuit.

FIG. 8 illustrates a timing diagram of the switch control signal, the output current, the current sensing signal, the default voltage, the enable signal and the latch signal when the second determination circuit is operated.

FIG. 9 illustrates a timing diagram of the switch control signal, the output current, the current sensing signal, the default voltage, the enable signal and the latch signal when the first determination circuit and the second determination circuit are operated at the same time.

FIG. 10 illustrates a flow chart of the buck-boost mode switching method in another embodiment of the invention.

### DETAILED DESCRIPTION OF THE INVENTION

Exemplary embodiments of the invention are referenced in detail now, and examples of the exemplary embodiments are illustrated in the drawings. Further, the same or similar reference numerals of the elements/components in the drawings and the detailed description of the invention are used on behalf of the same or similar parts.

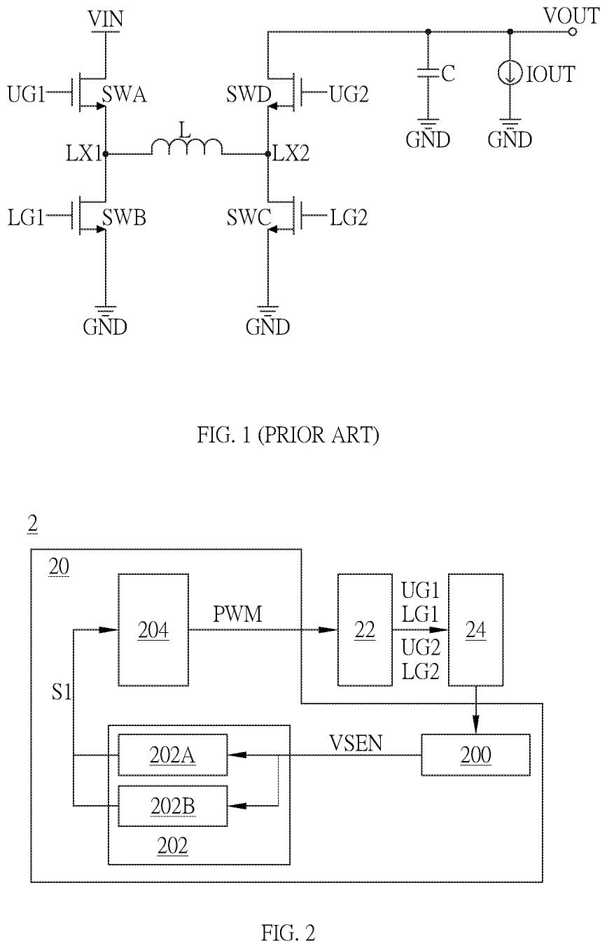

In the invention, an output current refers to a current flowing through an inductor L in FIG. 1 or a current flowing through a switch SWD when the switch SWD is turned on in FIG. 1.

An embodiment of the invention is a control circuit of a buck-boost converting apparatus. In this embodiment, the buck-boost converting apparatus can be a DC-DC buck-boost converting apparatus with a four-switch output stage, and its control circuit can determine whether the buck-boost converting apparatus should be operated in a buck mode, a boost mode or a buck-boost mode according to an output current sensing result of the buck-boost converting apparatus, but not limited to this.

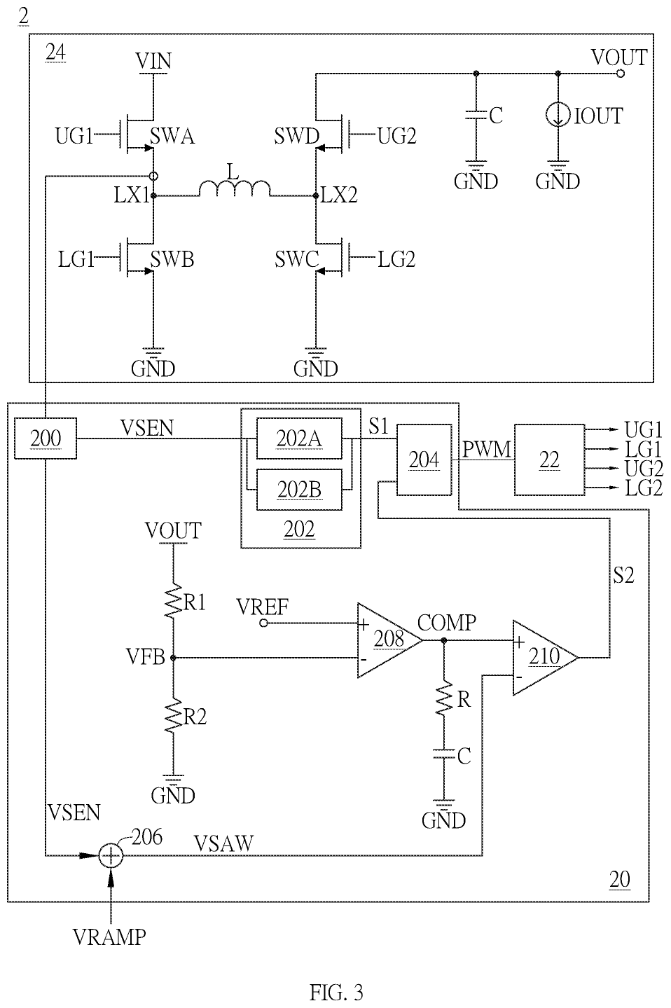

Please refer to FIG. 2. FIG. 2 illustrates a schematic diagram of the buck-boost converting apparatus in this embodiment. As shown in FIG. 2, the buck-boost converting apparatus 2 includes a control circuit 20, a driver 22 and an output stage 24. The control circuit 20 is coupled to the driver 22 and the output stage 24 respectively. The driver 22 is coupled to the control circuit 20 and the output stage 24 respectively. The output stage 24 is coupled to the driver 22 and the control circuit 20 respectively.

The control circuit 20 includes a current sensing circuit 200, a mode determination circuit 202 and a pulse width modulation generation circuit 204. The current sensing circuit 200 is coupled to the output stage 24 and the mode determination circuit 202 respectively. The mode determination circuit 202 is coupled to the current sensing circuit 200 and the pulse width modulation generation circuit 204 respectively. The pulse width modulation generation circuit 204 is coupled to the mode determination circuit 202 and the driver 22 respectively.

The current sensing circuit 200 is configured to sense the output current IOUT of the output stage 24 and generate a current sensing signal VSEN to the current sensing circuit 200 accordingly. In practical applications, the current sensing signal VSEN provided by the current sensing circuit 200 can be in a form of voltage or current without particular limitations.

The mode determination circuit 202 is configured to receive the current sensing signal VSEN provided by the current sensing circuit 200 and generate a switching control signal S1 to the pulse width modulation generation circuit 204 accordingly. The mode determination circuit 202 includes a first determination circuit 202A and a second determination circuit 202B.

The first determination circuit 202A is coupled to the current sensing circuit 200 and the pulse width modulation generation circuit 204 respectively and configured to determine a switching of the buck-boost converting apparatus 2 between the buck mode and the buck-boost mode according to the current sensing signal VSEN and the default voltage and generate a switching control signal S1 according to the above-mentioned determination result to control the buck-boost converting apparatus 2 to be operated in the buck mode or the buck-boost mode.

That is to say, when the buck-boost converting apparatus 2 is operated in the buck mode, the first determination circuit 202A can determine that the buck-boost converting apparatus 2 should be maintained to be operated in the buck mode or should be switched to the buck-boost mode according to a comparison result of the current sensing signal VSEN and the default voltage.

Similarly, when the buck-boost converting apparatus 2 is operated in the buck-boost mode, the first determination circuit 202A can also determine that the buck-boost converting apparatus 2 should be maintained to be operated in the buck-boost mode or should be switched to the boost mode according to the comparison result of the current sensing signal VSEN and the default voltage.

The second determination circuit 202B is coupled to the current sensing circuit 200 and the pulse width modulation generation circuit 204 respectively, and the second determination circuit 202B is configured to determine a switching of the second determination circuit 202B between the buck-boost mode and the boost mode according to the current sensing signal VSEN and the default voltage and generate a switching control signal S1 according to the above-mentioned determination result to control the buck-boost converting apparatus 2 to be operated in the buck-boost mode or the boost mode.

That is to say, when the buck-boost converting apparatus 2 is operated in the boost mode, the second determination circuit 202B can determine that the buck-boost converting apparatus 2 should be maintained to be operated in the boost mode or should be switched to the buck-boost mode according to the comparison result of the current sensing signal VSEN and the default voltage.

Similarly, when the buck-boost converting apparatus 2 is operated in the buck-boost mode, the second determination circuit 202B can also determine that the buck-boost converting apparatus 2 should be maintained to be operated in the buck-boost mode or should be switched to the boost mode according to the comparison result of the current sensing signal VSEN and the default voltage.

When the pulse width modulation generation circuit 204 receives the switching control signal S1 from the mode determination circuit 202, the pulse width modulation generation circuit 204 generates a corresponding pulse width modulation signal PWM to the driver 22 according to the switching control signal S1, and then the driver 22 correspondingly generates a plurality of switch control signals UG1, LG1, UG2 and LG2 to the output stage 24 according to the pulse width modulation signal PWM received by the driver 22, so as to control the operations of the plurality of switches in the output stage 24 respectively.

Please refer to FIG. 3. FIG. 3 illustrates a detailed schematic diagram of the buck-boost converting apparatus 2. As shown in FIG. 3, in addition to the current sensing circuit 200, the mode determination circuit 202 and the pulse width modulation generation circuit 204, the control circuit 20 also includes an adding unit 206, an error amplifier 208, a comparator 210, a voltage-dividing resistor R1˜R2, a resistor R and a capacitor C.

The current sensing circuit 200 is coupled to the mode determination circuit 202 and the adding unit 206 respectively and configured to provide the current sensing signal VSEN to the mode determination circuit 202 and the adding unit 206 respectively. The adding unit 206 is coupled to the current sensing circuit 200 and the negative input terminal− of the comparator 210 respectively and configured to receive the current sensing signal VSEN and the ramp signal VRAMP respectively and add the current sensing signal VSEN and the ramp signal VRAMP to generate an added signal VSAW to the negative input terminal− of the comparator 210.

The voltage-dividing resistors R1 and R2 are coupled in series between the output voltage VOUT and the ground terminal GND. There is a feedback voltage VFB between the voltage-dividing resistors R1 and R2 and the feedback voltage VFB is a divided voltage of the output voltage VOUT. The positive input terminal+ and the negative input terminal − of the error amplifier 208 receive the reference voltage VREF and the feedback voltage VFB respectively and generate an error amplification signal COMP to the positive input terminal+ of the comparator 210 accordingly. The resistor R and the capacitor C are coupled in series between the output terminal of the error amplifier 208 and the ground terminal GND.

When the positive input terminal+ and the negative input terminal − of the comparator 210 receive the error amplification signal COMP and the added signal VSAW respectively, the comparator 210 compares the error amplification signal COMP and the added signal VSAW and generates a comparison signal S2 to the pulse width modulation generation circuit 204 according to the above-mentioned comparison result.

When the pulse width modulation generation circuit 204 receives the switching control signal S1 provided by the mode determination circuit 202 and the comparison signal S2 provided by the comparator 210, the pulse width modulation generation circuit 204 generates corresponding pulse width modulation signals PWM to the driver 22 according to the switching control signals S1 and the comparison signal S2, and then the driver 22 correspondingly generates a plurality of switch control signals UG1, LG1, UG2 and LG2 to the output stage 24 according to the pulse width modulation signals PWM.

The output stage 24 includes four switches SWA˜SWD, an output inductor L and an output capacitor C. The switches SWA and SWB are coupled in series between the input voltage VIN and the ground terminal GND. The gates of the switches SWA and SWB are controlled by the switch control signals UG1 and LG1 respectively, and the switches SWA and SWB are not turned on at the same time. The switches SWD and SWC are coupled in series between the output voltage VOUT and the ground terminal GND. The gates of the switches SWD and SWC are controlled by the switch control signals UG2 and LG2 respectively, and the switches SWD and SWC are not turned on at the same time. One terminal of the output inductor L is coupled to a node LX1 between the switches SWA and SWB and the other terminal of the output inductor L is coupled to a node LX2 between the switches SWD and SWC. The current sensing circuit 200 is coupled to the node LX1 to sense the output current IOUT and generate the current sensing signal VSEN accordingly.

Please refer to FIG. 4. FIG. 4 illustrates a schematic diagram of the pulse width modulation generation circuit 204 including a mode switching circuit 204A. As shown in FIG. 4, the mode determination circuit 202 includes a first determination circuit 202A and a second determination circuit 202B. The pulse width modulation generation circuit 204 includes a mode switching circuit 204A and a pulse width modulation generator 204B. Both the first determination circuit 202A and the second determination circuit 202B are coupled to the mode switching circuit 204A. The mode switching circuit 204A is coupled to the pulse width modulation generator 204B.

In this embodiment, the mode switching circuit 204A includes latch units LA1˜LA3 and OR gates OR1˜OR2. An output terminal A1 of the first determination circuit 202A is coupled to an input terminal S of the latch unit LA1 and an input terminal of the OR gate OR2 respectively. An output terminal A2 of the first determination circuit 202A is coupled to an input terminal R of the latch unit LA1 and an input terminal of the OR gate OR1 respectively. An output terminal B1 of the second determination circuit 202B is coupled to an input terminal S of the latch unit LA3 and the other input terminal of the OR gate OR2 respectively. An output terminal B2 of the second determination circuit 202B is coupled to an input terminal R of the latch unit LA3 and the other input terminal of the OR gate OR1 respectively. An output terminal of the OR gate OR1 is coupled to an input terminal S of the latch unit LA2 and an output terminal of the OR gate OR2 is coupled to an input terminal R of the latch unit LA2. Output terminals Q of the latch units LA1˜LA3 are all coupled to the pulse width modulation generator 204B.

When the first determination circuit 202A determines that the buck-boost converting apparatus 2 should be operated in the buck mode, the first determination circuit 202A outputs the switching control signal S1 to the input terminal S of the latch unit LA1 and an input terminal of the OR gate OR2; when the first determination circuit 202A determines that the buck-boost converting apparatus 2 should be operated in the buck-boost mode, the first determination circuit 202A outputs the switching control signal S1 to the input terminal R of the latch unit LA1 and an input terminal of the OR gate OR1 through the output terminal A2.

Similarly, when the second determination circuit 202B determines that the buck-boost converting apparatus 2 should be operated in the boost mode, the second determination circuit 202B outputs the switching control signal S1 to the input terminal S of the latch unit LA3 and the other input terminal of the OR gate OR2 through the output terminal B1; when the second determination circuit 202B determines that the buck-boost converting apparatus 2 should be operated in the buck-boost mode, the second determination circuit 202B outputs the switching control signal S1 to the input terminal R of the latch unit LA3 and the other input terminal of the OR gate OR1 through the output terminal B2.

The latch units LA1˜LA3 in the mode switching circuit 204A generate the mode switching signal S3 corresponding to the buck mode, the buck-boost mode or the boost mode to the pulse width modulation generator 204B respectively according to the switching control signal S1 provided by the first determination circuit 202A or the second determination circuit 202B, and then the pulse width modulation generator 204B generates a pulse width modulation signal PWM corresponding to the buck mode, the buck-boost mode or the boost mode according to the mode switching signal S3.

For example, when the input terminal S of the latch unit LA1 in the mode switching circuit 204A receives the switching control signal S1, it means that the buck-boost converting apparatus 2 should be operated in the buck mode. Therefore, the latch unit LA1 will correspondingly generate the mode switching signal S3 (M1) corresponding to the buck mode to the pulse width modulation generator 204B, and then the pulse width modulation generator 204B will generate the pulse width modulation signal PWM (M1) corresponding to the buck mode according to the mode switching signal S3 (M1).

Similarly, when the input terminal S of the latch unit LA3 in the mode switching circuit 204A receives the switching control signal S1, it means that the buck-boost converting apparatus 2 should be operated in the boost mode. Therefore, the latch unit LA3 will correspondingly generate the mode switching signal S3 (M2) corresponding to the boost mode to the pulse width modulation generator 204B, and then the pulse width modulation generator 204B will generate the pulse width modulation signal PWM (M2) corresponding to the boost mode according to the mode switching signal S3 (M2).

Similarly, when any input terminal of the OR gate OR1 in the mode switching circuit 204A receives the switching control signal S1, it means that the buck-boost converting apparatus 2 should be operated in the buck-boost mode. Therefore, the latch unit LA2 will correspondingly generate the mode switching signal S3 (M3) corresponding to the buck-boost mode to the pulse width modulation generator 204B, and then the pulse width modulation generator 204B will generate the pulse width modulation signal PWM (M3) corresponding to the buck-boost mode according to the mode switching signal S3 (M3).

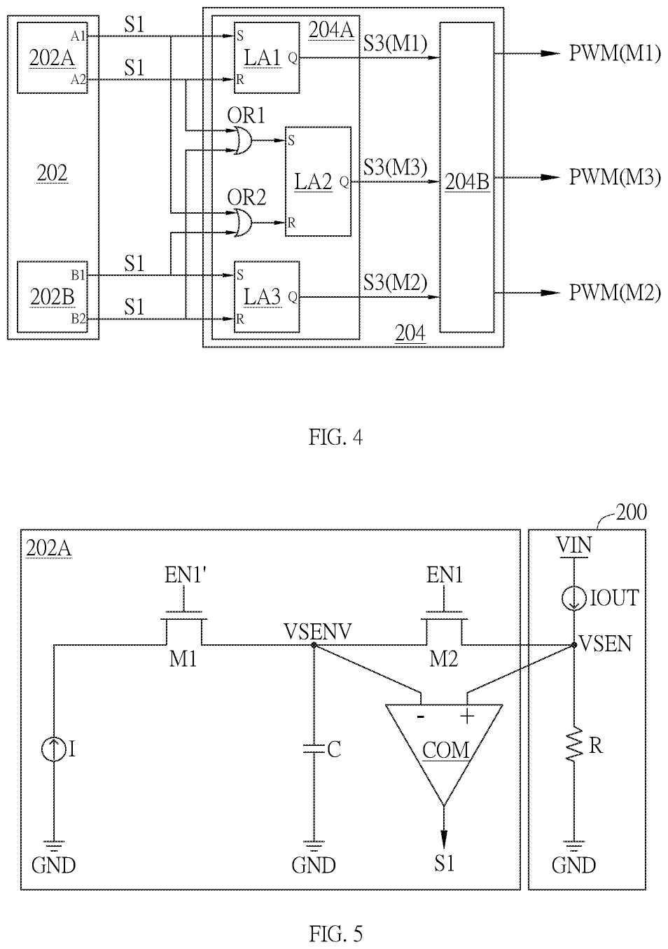

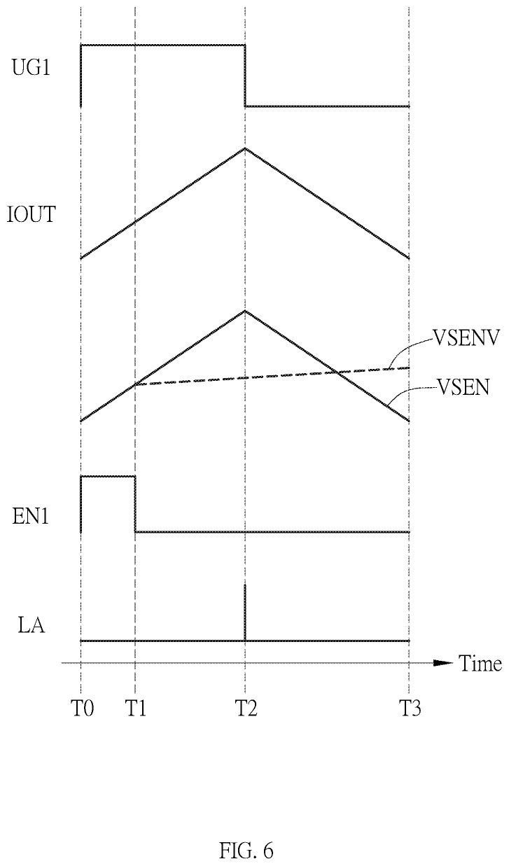

Please refer to FIG. 5. FIG. 5 illustrates an embodiment of the first determination circuit 202A and the current sensing circuit 200. As shown in FIG. 5, the first determination circuit 202A includes a default current I, switches M1˜M2, a capacitor C and a comparator COM. The default current I is coupled between the switch M1 and the ground terminal GND. The switch M1 is coupled between the default current I and the switch M2, and the gate of the switch M1 is controlled by the inverse enable signal EN1′. One terminal of the capacitor C is coupled between the switches M1 and M2 and the other terminal of the capacitor C is coupled to the ground terminal GND. The switch M2 is coupled between the switch M1 and the resistor R, and the gate of the switch M2 is controlled by the enable signal EN1.

The current sensing circuit 200 includes a resistor R used for sensing the output current IOUT to generate a current sensing signal VSEN between the switch M2 and the resistor R. The first determination circuit 202A generates a default voltage VSENV between the switches M1 and M2 according to the current sensing signal VSEN and the default current I.

The positive input terminal+ of the comparator COM is coupled between the switch M2 and the resistor R and the negative input terminal − of the comparator COM is coupled between the switches M1 and M2. The positive input terminal+ and the negative input terminal − of the comparator COM receive the current sensing signal VSEN and the default voltage VSENV respectively, and generate a switching control signal S1 according to a comparison result between the current sensing signal VSEN and the default voltage VSENV.

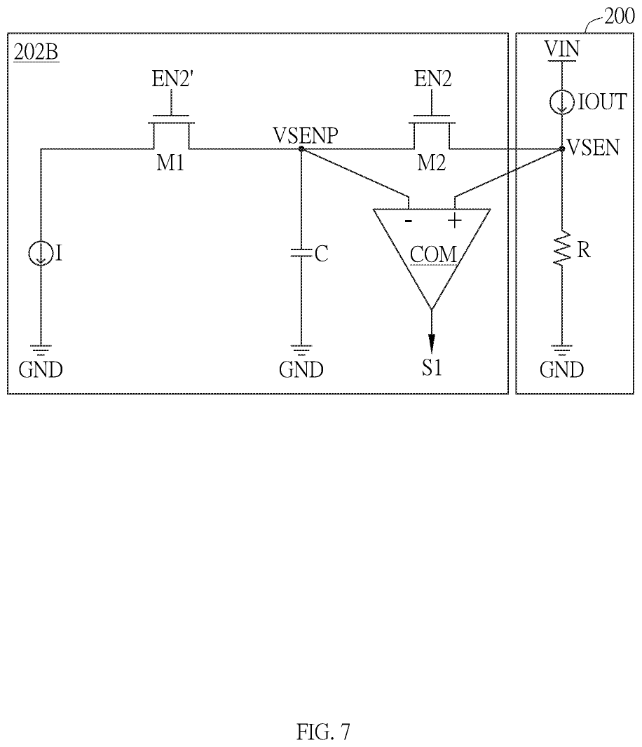

For example, as shown in FIG. 6, when the buck-boost converting apparatus 2 is operated in the buck mode, the switch control signal UG1 controlling the switch SWA in the output stage 24 is at high-level at the time T0 to the time T2 and at low-level at the time T2 to the time T3, that is to say, during the time T0 to the time T2, the switch SWA in the output stage 24 is turned on and the switch SWB in the output stage 24 is turned off; during the time T2 to the time T3, the switch SWA in the output stage 24 is turned off and the switch SWB in the output stage 24 is turned off.

During the period from the time T0 to the time T2, the output current IOUT rises linearly with time, and its slope is [(the input voltage VIN−the output voltage VOUT)/the output inductance L]; during the period from the time T2 to the time T3, the output current IOUT will decrease linearly with time, and its slope is [(−the output voltage VOUT)/the output inductance L]. As for the curve of the current sensing signal VSEN will also be consistent with the output current IOUT, so it will not be repeated here.

During the period from the time T0 to the time T1, the enable signal EN1 is at high-level, so that the switch M2 is turned on under the control of the enable signal EN1, and the switch M1 is turned off under the control of the inverse enable signal EN1′; during the period from the time T1 to the time T3, the enable signal EN1 is at low-level, so that the switch M2 is turned off under the control of the enable signal EN1, and the switch M1 is turned on under the control of the inverted enable signal EN1′.

At the time T1, the current sensing signal VSEN is equal to the default voltage VSENV. Next, since the default current I makes different climbing slopes of the default voltage VSENV and the current sensing signal VSEN, there will be a difference between them.

At the time T2, the latch signal LA triggers the first determination circuit 202A to compare the current sensing signal VSEN larger than the default voltage VSENV, which means that the buck-boost converting apparatus 2 should be maintained to be operated in the buck mode, so that the first determination circuit 202A correspondingly generates a switching control signal S1 to control the buck-boost converting apparatus 2 to be maintained to be operated in the buck mode.

In other words, during the period from the time T1 to the time T2, if the absolute value of the current change slope of the output current IUOT is smaller than the absolute value of the current change slope of the default current I, the buck-boost converting apparatus 2 enters the buck-boost mode; otherwise, the buck-boost voltage converting apparatus 2 is released from the buck-boost mode.

As for the case where the buck-boost converting apparatus 2 is operated in the buck-boost mode, the first determination circuit 202A determines that the buck-boost converting apparatus 2 should be maintained to be operated in the buck-boost mode or switched to the buck mode. It can be deduced by analogy, so it will not be repeated here.

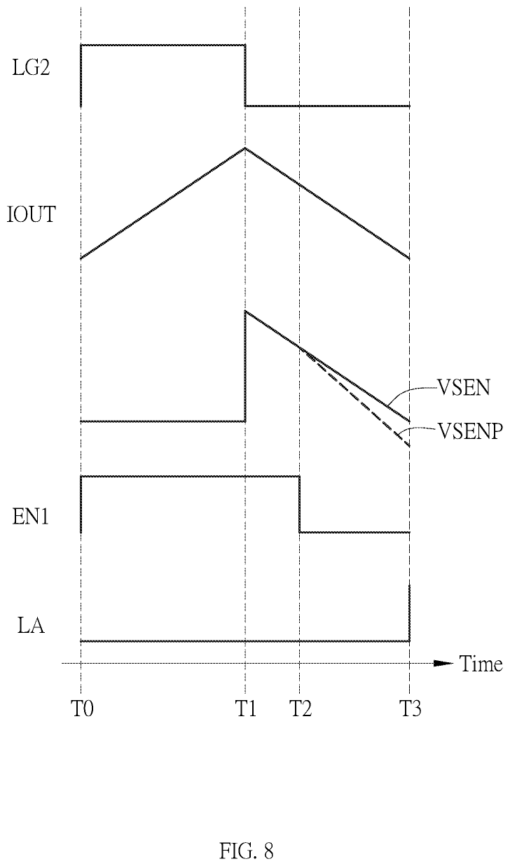

Please refer to FIG. 7. FIG. 7 illustrates an embodiment of the second determination circuit 202B and the current sensing circuit 200. As shown in FIG. 7, the second determination circuit 202B includes a default current I, switches M1˜M2, a capacitor C and a comparator COM. The default current I is coupled between the switch M1 and the ground terminal GND. The switch M1 is coupled between the default current I and the switch M2, and the gate of the switch M1 is controlled by the inverse enable signal EN2′. One terminal of the capacitor C is coupled between the switches M1 and M2 and the other terminal of the capacitor C is coupled to the ground terminal GND. The switch M2 is coupled between the switch M1 and the resistor R, and the gate of the switch M2 is controlled by the enable signal EN2.

The current sensing circuit 200 includes a resistor R used for sensing an output current IOUT to generate a current sensing signal VSEN between the switch M2 and the resistor R. The second determination circuit 202B generates a default voltage VSENP between the switches M1 and M2 according to the current sensing signal VSEN and the default current I.

The positive input terminal+ of the comparator COM is coupled between the switch M2 and the resistor R and the negative input terminal − of the comparator COM is coupled between the switches M1 and M2. The positive input terminal+ and the negative input terminal − of the comparator COM receive the current sensing signal VSEN and the default voltage VSENP respectively and generate a switching control signal S1 according to the comparison result between the current sensing signal VSEN and the default voltage VSENP.

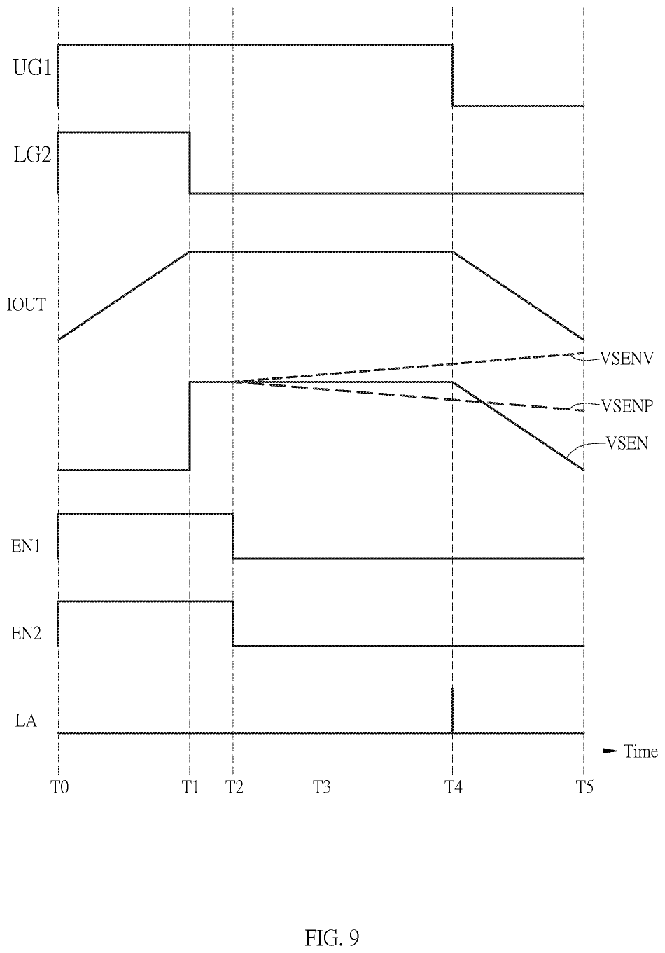

For example, as shown in FIG. 8, when the buck-boost converting apparatus 2 is operated in the buck-boost mode, the switch control signal UG2 controlling the switch SWC in the output stage 24 is at high-level from the time T0 to the time T1 and at low-level from the time T1 to the time T3; that is to say, during the period from the time T0 to the time T1, the switch SWC in the output stage 24 is turned on and the switch SWD in the output stage 24 is turned off; during period from the time T1 to the time T3, the switch SWC in the output stage 24 is turned off and the switch SWD in the output stage 24 is tuned on.

During the period from the time T0 to the time T1, the output current IOUT will rise linearly with time, its slope=(the input voltage VIN/the output inductance L), and the current sensing signal VSEN is zero; during the period from the time T1 to the time T3, the output current IOUT decreases linearly with time, and its slope=[(the input voltage VIN−the output voltage VOUT)/the output inductance L], and the curve of the current sensing signal VSEN is consistent with the output current IOUT.

During the period from the time T0 to the time T2, the enable signal EN2 is at high-level, so that the switch M2 is turned on under the control of the enable signal EN2, and the switch M1 is turned off under the control of the inverse enable signal EN2′; during the period from the time T2 to the time T3, the enable signal EN2 is at low-level, so that the switch M2 is turned off under the control of the enable signal EN2, and the switch M1 is turned on under the control of the inverted enable signal EN2′.

At the time T2, the second determination circuit 202B determines that the current sensing signal VSEN is equal to the default voltage VSENP. Next, since the slopes of the default voltage VSENP and the current sensing signal VSEN are different, there will be a difference between them.

At the time T3, the second determination circuit 202B determines that the current sensing signal VSEN is higher than the default voltage VSENP, it means that the buck-boost converting apparatus 2 should be maintained to be operated in the buck-boost mode, so that the second determination circuit 202B generates a switching control signal S1 correspondingly to control the buck-boost voltage converting apparatus 2 to be maintained to be operated in the buck-boost mode.

Similarly, if the second determination circuit 202B determines that the current sensing signal VSEN is lower than the default voltage VSENP, it means that the buck-boost converting apparatus 2 should be switched to the boost mode, so that the second determination circuit 202B generates a switching control signal S1 correspondingly to control the buck-boost voltage converting apparatus 2 to be switched to the boost mode.

As for the case where the buck-boost converting apparatus 2 is operated in the buck-boost mode, the second determination circuit 202B determines that the buck-boost converting apparatus 2 should be maintained to be operated in the buck-boost mode or switched to the boost mode. It can be deduced by analogy, so it will not be repeated here.

Next, please refer to FIG. 9. FIG. 9 illustrates timing diagrams of the switch control signals UG1 and LG2, the output current IOUT, the current sensing signal VSEN and the default voltage VSENV VSENP, enable signals EN1˜EN2 and latch signal LA when the first determination circuit 202A and the second determination circuit 202B are operated simultaneously.

As shown in FIG. 9, it is assumed that the buck-boost converting apparatus 2 is operated in the boost mode during the period from the time T0 to the time T3 and the buck-boost converting apparatus 2 is operated in the buck mode during the period from the time T3 to the time T5.

When the buck-boost converting apparatus 2 is operated in the boost mode during the period from the time T0 to the time T3, the switch SWC in the output stage 24 is turned on and the switch SWD in the output stage 24 is turned off during the period from the time T0 to the time T1; the switch SWC in the output stage 24 is turned off and the switch SWD in the output stage 24 is turned on during the period from the time T1 to the time T3.

During the period from the time T0 to the time T1, the output current IOUT will rise linearly with time, its slope=(the input voltage VIN/the output inductance L), and the current sensing signal VSEN is zero; during the period from the time T1 to the time T3, the output current IOUT remains unchanged, and its slope=[(the input voltage VIN−the output voltage VOUT)/the output inductance L], and the current sensing signal VSEN is consistent with the output current IOUT.

During the period from the time T0 to the time T2, the enable signals EN1 and EN2 are both at high-level, so that the switches M2 in the first determination circuit 202A and the second determination circuit 202B are turned on under the control of the enable signals EN1 and EN2 respectively. And, the switches M1 in the first determination circuit 202A and the second determination circuit 202B are turned off under the control of the inversion enabling signals EN1′ and EN2′ respectively; during the period from the time T2 to the time T5, the enabling signals EN1 and EN2 are both low-level, so that the switches M2 in the first determination circuit 202A and the second determination circuit 202B are turned off under the control of the enable signals EN1 and EN2 respectively. And, the switches M1 in the first determination circuit 202A and the second determination circuit 202B are turned on under the control of the inversion enable signals EN1 ‘and EN2’ respectively.

At the time T2, the first determination circuit 202A determines that the current sensing signal VSEN is equal to the default voltage VSENV and the second determination circuit 202B determines that the current sensing signal VSEN is equal to the default voltage VSENP. Next, since the default current I causes the slopes of the default voltages VSENV and VSENP and the current sensing signal VSEN to be different, differences will occur between them after the time T2.

At the time T4, the buck-boost converting apparatus 2 is operated in the buck-boost mode. The first determination circuit 202A determines that the current sensing signal VSEN is lower than the default voltage VSENV, it means that the buck-boost converting apparatus 2 should be maintained to be operated in the buck-boost mode. Therefore, the first determination circuit 202A generates a switching control signal S1 to control the buck-boost voltage converting apparatus 2 to be maintained to be operated in the buck-boost mode. The rest can be deduced by analogy, so it will not be repeated here.

Another embodiment of the invention is a buck-boost mode switching method. In this embodiment, the buck-boost mode switching method is applied to a buck-boost converting apparatus to determine that the buck-boost converting apparatus should be operated in the buck mode, the buck-boost mode or the boost mode, but not limited to this.

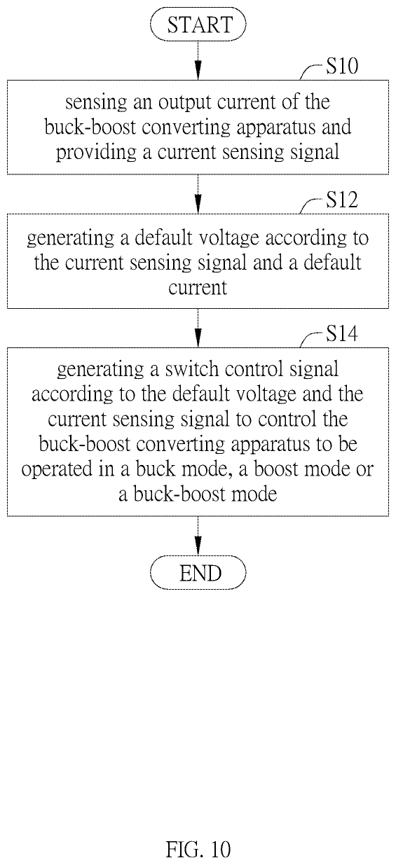

Please refer to FIG. 10. FIG. 10 illustrates a flowchart of the buck-boost mode switching method in this embodiment. As shown in FIG. 10, the buck-boost mode switching method includes the following steps:

Step S10: sensing an output current of the buck-boost converting apparatus and providing a current sensing signal;

Step S12: generating a default voltage according to the current sensing signal and a default current; and

Step S14: generating a switch control signal according to the default voltage and the current sensing signal to control the buck-boost converting apparatus to be operated in a buck mode, a boost mode or a buck-boost mode.

As for other detailed implementation aspects of the buck-boost mode switching method, reference may be made to the relevant descriptions of the foregoing embodiments, and details are not described herein again.

Compared to the prior art, the control circuit of the buck-boost converting apparatus and the buck-boost mode switching method of the same in the invention can determine whether the operation mode of the buck-boost converting apparatus should be switched or not according to the output current sensing result of the buck-boost converting apparatus, so that the problem that the buck-boost converting apparatus is continuously switched between different operation modes because the comparator fails to perform accurate determination according to the comparison result of the input voltage and the output voltage in the prior art can be effectively avoided, so that the buck-boost converting apparatus of the invention can be continuously operated in correct operation mode to provide optimal voltage converting performance.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A control circuit of a buck-boost converting apparatus, comprising:
a current sensing circuit, configured to sense an output current of the buck-boost converting apparatus and provide a current sensing signal; and
a mode determination circuit, coupled to the current sensing circuit and configured to receive the current sensing signal,
wherein the mode determination circuit generates a default voltage according to the current sensing signal and a default current, and the mode determination circuit generates a switching control signal according to the default voltage and the current sensing signal to control the buck-boost converting apparatus to be operated in a buck mode, a boost mode or a buck-boost mode.

2. The control circuit of claim 1, further comprising:
a pulse width modulation generation circuit, coupled to the mode determination circuit and configured to generate a pulse width modulation signal according to the switching control signal.

3. The control circuit of claim 2, wherein the buck-boost converting apparatus further comprises a driver and an output stage, the driver is coupled between the pulse width modulation generation circuit and the output stage and configured to generate a plurality of switch control signals to the output stage according to the pulse width modulation signal.

4. The control circuit of claim 2, wherein the pulse width modulation generation circuit further comprises:
a mode switching circuit, coupled to the mode determination circuit and configured to generate a mode switching signal corresponding to the buck mode, the boost mode or the buck-boost mode according to the switch control signal; and
a pulse width modulation generator, coupled to the mode switching circuit and configured to generate the pulse width modulation signal corresponding to the buck mode, the boost mode or the buck-boost mode according to the mode switching signal.

5. The control circuit of claim 1, wherein the mode determination circuit comprises:
a first determination circuit, configured to determine a switching between the buck mode and the buck-boost mode according to the default voltage and the current sensing signal; and
a second determination circuit, configured to determine a switching between the buck-boost mode and the boost mode according to the default voltage and the current sensing signal.

6. The control circuit of claim 5, wherein the current sensing signal is equal to the default voltage at a first time, and the first determination circuit compares the current sensing signal and the default voltage at a second time to generate the switch control signal to control the buck-boost converting apparatus to be operated in the buck mode or the buck-boost mode, and the second time is later than the first time.

7. The control circuit of claim 5, wherein the current sensing signal is equal to the default voltage at a first time, and the second determination circuit compares the current sensing signal with the default voltage at a second time to generate the switch control signal to control the buck-boost converting apparatus to be operated in the buck-boost mode or the boost mode, and the second time is later than the first time.

8. A buck-boost mode switching method, applied to a buck-boost converting apparatus, comprising steps of:
sensing an output current of the buck-boost converting apparatus and providing a current sensing signal;
generating a default voltage according to the current sensing signal and a default current; and
generating a switch control signal according to the default voltage and the current sensing signal to control the buck-boost converting apparatus to be operated in a buck mode, a boost mode or a buck-boost mode.

9. The buck-boost mode switching method of claim 8, further comprising:
generating a pulse width modulation signal according to the switching control signal; and
generating a plurality of switch control signals to an output stage of the buck-boost converting apparatus according to the pulse width modulation signal.

10. The buck-boost mode switching method of claim 9, further comprising:
generating a mode switching signal corresponding to the buck mode, the boost mode or the buck-boost mode according to the switch control signal; and
generating the pulse width modulation signal corresponding to the buck mode, the boost mode or the buck-boost mode according to the mode switching signal.

11. The buck-boost mode switching method of claim 8, further comprising:
determining a switching between the buck mode and the buck-boost mode according to the default voltage and the current sensing signal; and
determining a switching between the buck-boost mode and the boost mode according to the default voltage and the current sensing signal.

12. The buck-boost mode switching method of claim 11, further comprising:
making the current sensing signal equal to the default voltage at a first time, and comparing the current sensing signal with the default voltage at a second time to generate the switch control signal, wherein the second time is later than the first time;
if the current sensing signal is higher than the default voltage, controlling the buck-boost converting apparatus to be operated in the buck mode; and
if the current sensing signal is lower than the default voltage, controlling the buck-boost converting apparatus to be operated in the buck-boost mode.

13. The buck-boost mode switching method of claim 11, further comprising:
making the current sensing signal equal to the default voltage at a first time, and comparing the current sensing signal with the default voltage at a second time to generate the switch control signal, wherein the second time is later than the first time;
if the current sensing signal is lower than the default voltage, controlling the buck-boost converting apparatus to be operated in the buck-boost mode; and
if the current sensing signal is higher than the default voltage, controlling the buck-boost converting apparatus to be operated in the boost mode.
